(19) United States
(12) Patent Application Publication
(10) Pub. No.: US 2007/0160418 A1
(43) Pub. Date: Jul. 12, 2007

(54) Quick assembly bolt jacket

(76) Inventor: Boyce Lo, Yong-An Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/328,186

(22) Filed: Jan. 10, 2006

(51) Int. Cl. F16G 11/05

(52) U.S. Cl. 403/275; 439/275

(57) ABSTRACT

A jacket for a quick assembly bolt device includes a longitudinal through-hole having a neck section for firmly engaging with an end of a bolt that extends into the jacket. At least one longitudinal slit is defined in a circumference of the jacket, with a perimeter delimiting the at least one longitudinal slit jointing with an end of the jacket at least one jointing point. The jointing point is broken when the jacket is inserted into a bore of a piece of lumber, allowing the jacket to expand outward for firm engagement with a circumferential wall delimiting the bore of the piece of lumber. The longitudinal through-hole of the jacket allows the other end of the bolt to be driven into another piece of lumber.

### BACKGROUND OF THE INVENTION

1. Field of the Invention

The present invention relates to a bolt jacket More particularly, the present invention relates to a quick assembly bolt jacket.

2. Description of the Related Art

It is well known to use a bolt to combine lumber or the like for making a piece of furniture or for decoration purposes. In a conventional method, a bolt is extended from an outer side of a first piece of lumber into a second piece of lumber, with an end face of the bolt exposed outside and thus adversely affecting the appearance of the furniture or decoration.

To avoid exposure of the bolt, another type of bolt has been developed, such as the bolt disclosed in Taiwan Utility Model Application No. 90223491. The bolt of this type comprises a fastening member embedded in a first piece of lumber of a piece of furniture, a screwing member including an end threadedly engaged in the fastening member, and a jacket embedded in a bore of a second piece of lumber of the piece of furniture. An end of the jacket includes an annular wall face having a plurality of annular reinforcing ribs and longitudinal slits to allow the screwing member to press against the annular wall face of the jacket after the screwing member is inserted into the jacket, thereby securely fixing the bolt inside the furniture.

However, due to provision of the slits with open ends, the outer diameter of the screwing member has to be greater than a diameter of the bore of the second piece of furniture for securely fixing the jacket inside the furniture, leading to difficulty to assembly. Further, the user has to troublesomely embed the fastening member and the jacket into the pieces of lumber during assembly

### SUMMARY OF THE INVENTION

A jacket for a quick assembly bolt device in accordance with the present invention comprises a longitudinal through-hole including a neck section. At least one longitudinal slit is defined in a circumference of the jacket, with a perimeter delimiting the at least one longitudinal slit jointing with an end of the jacket at least one jointing point.

The jacket is adapted to be extended by an end of a bolt. The jacket receiving the end of the bolt is adapted to be inserted into a bore of a piece of lumber. The jointing point is broken when the jacket is inserted into the bore of the piece of lumber, allowing the jacket to expand outward for firm engagement with a circumferential wall delimiting the bore of the piece of lumber. The longitudinal through-hole of the jacket is adapted to allow the other end of the bolt to be driven into another piece of lumber. The neck portion of the jacket is adapted to be firmly engaged with the end of the bolt.

Preferably, the number of the at least one jointing point is four and the four jointing points are spaced at regular angular intervals.

Alternatively, the end of the jacket further comprises a flange, and the at least one jointing point is a notched section extending inward from a circumferential edge of the flange. Preferably, the at least one longitudinal slit does not extend into the flange.

Alternatively, the end of the jacket further comprises a flange. The at least one jointing point is a protruded section extending outward from a circumferential edge of the flange, and the at least one longitudinal slit extends into the flange.

Alternatively, the end of the jacket further comprises a flange, with two of the jointing points being two diametrically opposed notched sections extending inward from a circumferential edge of the flange, with the other two of the jointing points being two diametrically opposed protruded sections extending outward from the circumferential edge of the flange, and with the longitudinal slits corresponding to the protruded sections extending into the flange. Preferably, the longitudinal slits corresponding to the notched sections do not extend into the flange.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a quick assembly bolt device comprising a bolt and a jacket in accordance with the present invention.

FIG. 2 is an exploded perspective view of the bolt device in accordance with the present invention.

FIG. 3 is an exploded perspective view illustrating bolt device in accordance with the present invention and two pieces of lumber.

FIG. 4 is a sectional view illustrating the bolt device in accordance with the present invention in a semi-assembled state.

FIG. 5 is a sectional view similar to FIG. 4, illustrating an assembled state of the bolt device in accordance with the present invention.

FIG. 6 is a plan view illustrating four jointing points of the jacket in accordance with the present invention.

FIG. 7 is a perspective view illustrating a modified embodiment of the jacket in accordance with the present invention.

### DETAILED DESCRIPTION OF THE PREFERRED EMBODIMENTS

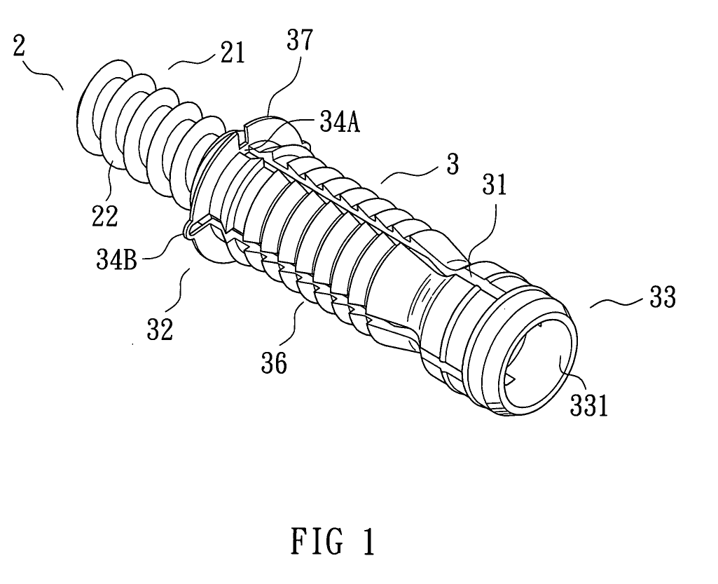

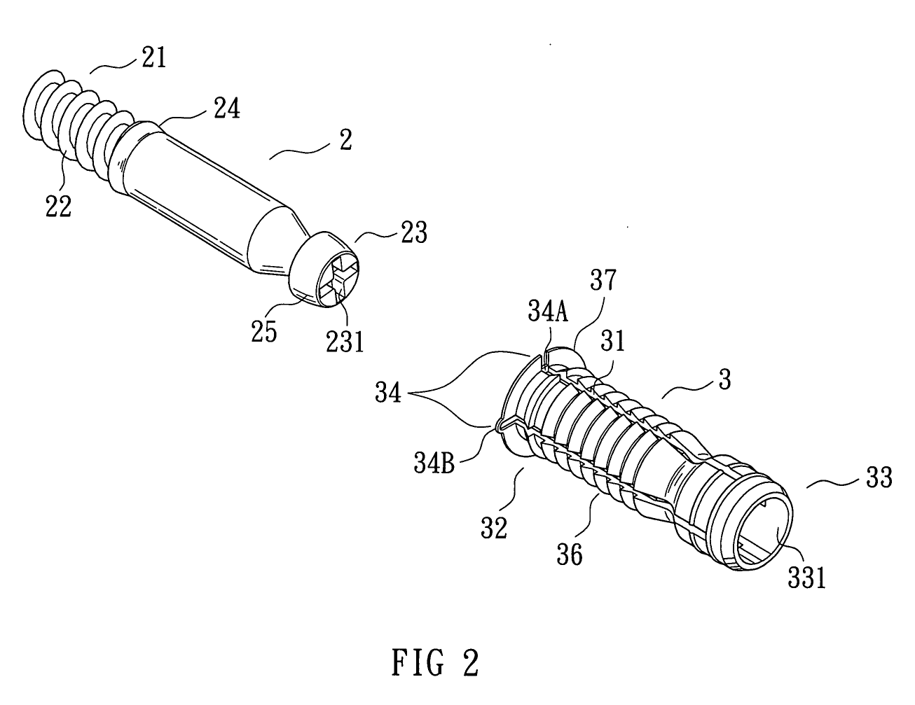

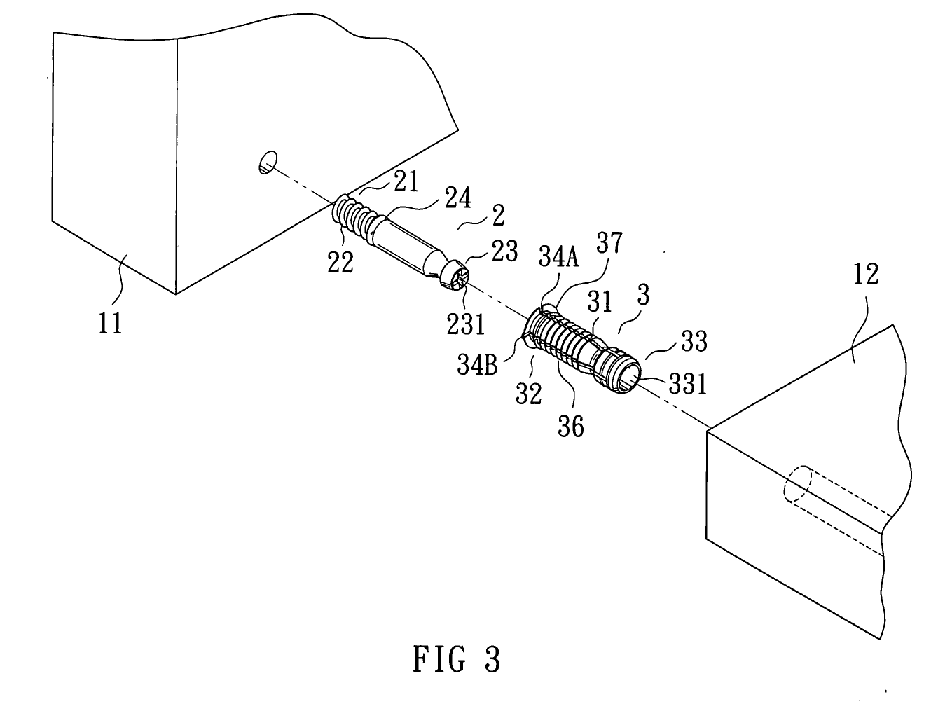

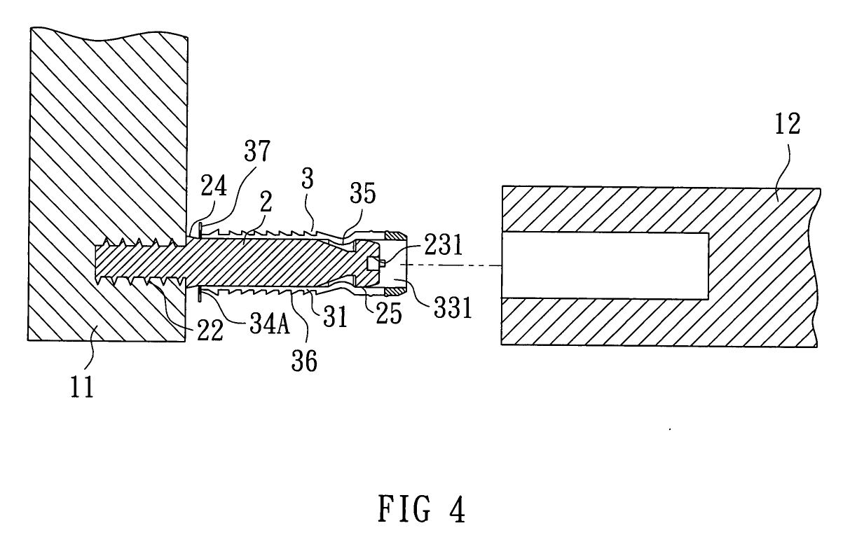

Referring to FIGS. 1 and 2, a quick assembly bolt device in accordance with the present invention comprises a bolt 2 and a jacket 3. The bolt 2 comprises a first end 21 with an outer threading 22, allowing the first end 21 of the bolt 2 to be engaged in a bore (not labeled) of a first piece of lumber 11. The bolt 2 further comprises a second end 23, with a slit or groove 231 defined in an end face of the second end 23. A bit (not shown) of an electric tool (not shown) may be passed through the jacket 3 and coupled with the groove 231 of the bolt 2 to drive the first end 21 of the bolt 2 into the bore of the first piece of lumber 11 (see FIGS. 3 and 4).

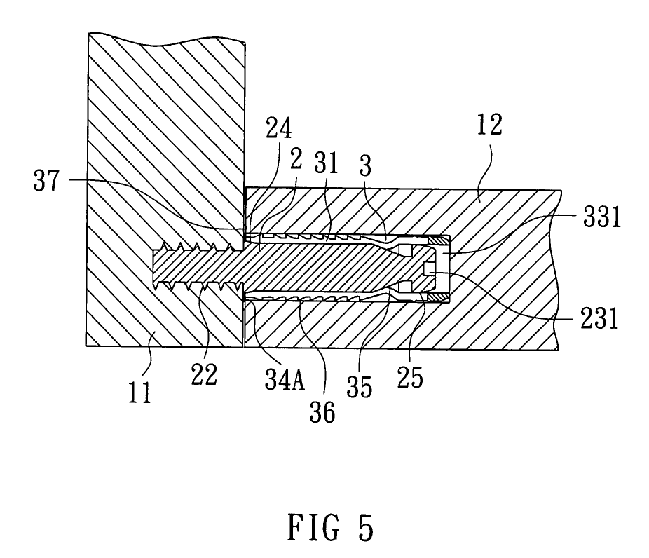

The bolt 2 further comprises a stop 24 (in the form of, e.g., an annular rib) on a circumference thereof and adjacent to the outer threading 22 on the first end 21 of the bolt 2. Referring to FIG. 5, when the bolt 2 is coupled with the jacket 3, which is then coupled with a second piece of lumber 12, the stop 24 abuts against an end face of the second piece of lumber 12.

Further, the second end 23 of the bolt 2 is substantially conic and preferably tapers from the first end 21 toward the second end 23 of the bolt 2, forming a hook section 25. The jacket 3 comprises a longitudinal through-hole 331 with a neck section 35 for coupling with the hook section 25 such that it is easy to insert the bolt 2 into the jacket 3 but difficult to remove the bolt 2 out of the jacket 3 in a reverse direction.

The jacket 3 is tubular and comprises an outer threading 36 on a circumference thereof, allowing the jacket 3 to be engaged in a bore (not labeled) of the second piece of lumber 12. The jacket 3 further comprises at least one longitudinal slit 31 (four in this embodiment) in the circumference thereof, with a perimeter delimiting each longitudinal slit 31 jointing with a first end 32 of the jacket 3 at a point 34. An end of the longitudinal through-hole 331 in a second end 33 of the jacket 3 allows the bit of the electric tool to couple with the groove 231 of the bolt 2 for driving the first end 21 of the bolt 2 into the bore of the first piece of lumber 11.

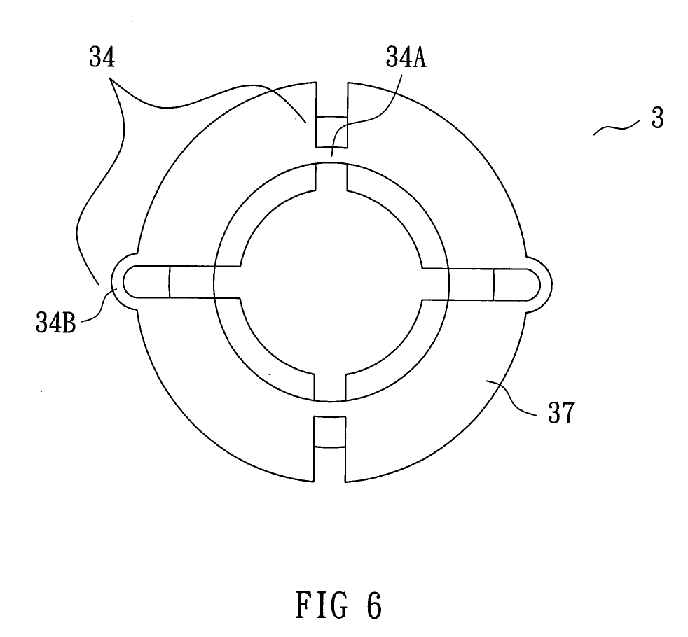

It is noted that the jointing points 34 of the jacket 3 may have different forms. In the illustrated embodiment, the jacket 3 comprises a flange 37 on an end face of the first end 32, and the jointing points include notched sections 34A and protruded sections 34B on the flange 37, with each notched section 34A extending inward from a circumferential edge of the flange 37, and with each protruded section 34B extending outward from the circumferential edge of the flange 37. The longitudinal slits 31 corresponding to the notched sections 34A do not extend into the flange 37. Nevertheless, the longitudinal slits 31 corresponding to the protruded sections 34B extend into the flange 37. As illustrated in FIG. 6, the notched sections 34A are preferably diametrically opposed to each other and the protruded sections 34B are preferably diametrically opposed to each other. Further, the notched sections 34A and the protruded sections 34B may be spaced at regular angular intervals. The notched sections 34A and the protruded sections 34B are fragile to allow easy destruction at the jointing points 34 and thus allow expansion of the jacket 3.

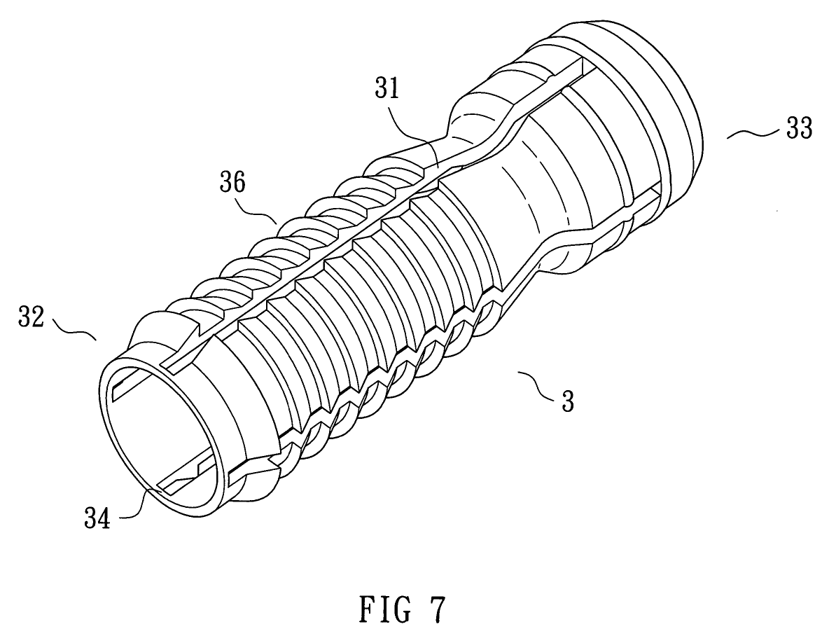

FIG. 7 illustrates a modified embodiment of the jacket 3 in accordance with the present invention, wherein the jacket 3 does not have a flange 37 on the first end 32. The jacket 3 may include at least one slit 31 in the circumference thereof. Preferably, the jacket 3 includes four longitudinal slits 31, with a perimeter delimiting each longitudinal slit 31 jointing with the first end 32 of the jacket 3 at a point 34. The jointing points 34 are preferably spaced at regular angular intervals.

In assembly, the second end 23 of the bolt 2 is inserted into the longitudinal through-hole 331 of the jacket 3, with the hook section 25 of the bolt 2 coupled with the neck section 35 of the jacket 3 and with the first end 21 of the bolt 2 exposed outside the jacket 3. Referring to FIG. 4, the first end 21 of the bolt 2 having outer threading 22 is driven into the bore of the first piece of lumber 11 by coupling a bit of an electric tool with the groove 231 of the bolt 2 via the longitudinal through-hole 331 of the jacket 3, as mentioned above. The jacket 3 is then inserted into the bore of the second piece of lumber 12, as shown in FIG. 5. It is noted that the fragile jointing points 34 of the jacket 3 break when the jacket 3 is inserted into the bore of the second piece of lumber 12. Thus, the jacket 3 expands outward due to the inserting force applied by the user, allowing the outer threading 36 of the jacket 3 to bite into and thus firmly engage with a circumferential wall delimiting the bore of the second piece of lumber 12. A quick assembly bolt device including a quick assembly bolt jacket is thus provided. After assembly, the stop 24 of the bolt 2 abuts against the end face of the first end 32 of the jacket 3. Preferably, the stop 24 of the bolt 2 abuts against the flange 37 of the first end 32 of the jacket 3.

Although specific embodiments have been illustrated and described, numerous modifications and variations are still possible without departing from the essence of the invention. The scope of the invention is limited by the accompanying claims.

What is claimed is:

1. A jacket for a quick assembly bolt device, the jacket comprising:
a longitudinal through-hole including a neck section;
at least one longitudinal slit in a circumference of the jacket, a perimeter delimiting said at least one longitudinal slit jointing with an end of the jacket at least one jointing point;
the jacket being adapted to be extended by an end of a bolt, the jacket receiving the end of the bolt being adapted to be inserted into a bore of a piece of lumber, with the jointing point being broken when the jacket is inserted into the bore of the piece of lumber, allowing the jacket to expand outward for firm engagement with a circumferential wall delimiting the bore of the piece of lumber, with the longitudinal through-hole of the jacket being adapted to allow another end of the bolt to be driven into another piece of lumber, and with the neck portion of the jacket being adapted to be firmly engaged with the end of the bolt.

2. The jacket for a quick assembly bolt device as claimed in claim 1, with the number of said at least one jointing point being four and with the four jointing points being spaced at regular angular intervals.

3. The jacket for a quick assembly bolt device as claimed in claim 1, with the end of the jacket further comprising a flange, and with said at least one jointing point being a notched section extending inward from a circumferential edge of the flange.

4. The jacket for a quick assembly bolt device as claimed in claim 3, with said at least one longitudinal slit not extending into the flange.

5. The jacket for a quick assembly bolt device as claimed in claim 1, with the end of the jacket further comprising a flange, with said at least one jointing point being a protruded section extending outward from a circumferential edge of the flange, and with said at least one longitudinal slit extending into the flange.

6. The jacket for a quick assembly bolt device as claimed in claim 2, with the end of the jacket further comprising a flange, with two of the jointing points being two diametrically opposed notched sections extending inward from a circumferential edge of the flange, with the other two of the jointing points being two diametrically opposed protruded sections extending outward from the circumferential edge of the flange, and with the longitudinal slits corresponding to the protruded sections extending into the flange.

7. The jacket for a quick assembly bolt device as claimed in claim 6, with the longitudinal slits corresponding to the notched sections not extending into the flange.
